(19) United States
(12) Patent Application Publication
(10) Pub. No.: US 2019/0166186 A1
(43) Pub. Date: May 30, 2019

(54) MULTICAST TRANSMISSION FOR ASYNCHRONOUS DATA REQUESTS

(71) Applicant: Korea Advanced Institute of Science and Technology, Daejeon (KR)

(72) Inventors: Wan CHOI, Daejeon (KR); Hojin SONG, Daejeon (KR)

(21) Appl. No.: 16/027,001

(22) Filed: Jul. 3, 2018

(30) Foreign Application Priority Data
Nov. 24, 2017 (KR) 10-2017-0158392

(51) Int. Cl. H04L 29/08; H04L 12/18; H04L 29/06

(52) U.S. Cl. CPC H04L 67/06; H04L 12/1881; H04L 65/4076; H04L 12/189

(57) ABSTRACT

Provided is a non-orthogonal multicast transmission for asynchronous data requests. In a multicast transmission method of multicasting data to a plurality of user devices belonging to a base station, the method may include: receiving a request for transmitting a file from user device 1 belonging to the base station; unicasting the requested file to the user device 1; receiving a request for transmitting the file unicast to the user device 1 from user device 2 belonging to the base station; and switching to multicast and multicasting the file after unicasting the file to the user device 1 and the user device 2 for a certain time.

### STATEMENT REGARDING FEDERALLY SPONSORED RESEARCH OR DEVELOPMENT

This invention was supported by Institute for Information & communications Technology Promotion (IITP) grant funded by the Korea government (MSIT) (No. 2015-0-00820, A research on a novel communication system using storage as wireless communication resource).

### CROSS-REFERENCE TO RELATED APPLICATIONS

The instant application is a U.S. non-provisional application which claims priority to Korean patent application No. 10-2017-0158392 filed on Nov. 24, 2017, the entire disclosure of which is hereby incorporated by reference.

### BACKGROUND OF THE INVENTION

### Field of the Invention

The present invention relates to a communication technique for efficiently transmitting a requested file via multicast transmission when user devices request the same file at different time points.

### Background of the Related Art

Due to rapid increase of wireless video devices such as smart phones, tablet computers and the like, requests for video streaming have increased particularly. Most of the requests for video streaming are requests for some popular files duplicately requested by multiple users, and requested data (file) can be simultaneously transmitted to a plurality of users in the form of multicast. However, since the time point of requesting a corresponding video is different from user to user in reality, probability of transmitting a file in the form of multicast is low when the file is transmitted wirelessly.

Conventionally, methods of effectively multicasting a file when a plurality of user devices (i.e., electronic devices such as a smart phone, a tablet computer, a notebook computer or the like possessed by users) request the same file have been studied. For example, as a method of asynchronously multicasting a file, a multicast method has been studied, in which although a user device requests a file for the first time, a file transfer service is not provided immediately, and the requested file is multicast when another user device requests the same file after a certain time is elapsed.

Other than this, there is a method of multicasting a file, in which if a first user device requests a file, the file is transmitted immediately, and if a second user device requests the same file while the requested file is transmitted, the file is multicast to the first and second user devices starting from the part being transmitted to the first user device at the time point of requesting the same file. In this case, the data of the front part that the second user device does not receive is provided to the second user device by using other wireless resources.

Like this, the method of multicasting a file after waiting for a certain time until another user device requests the same file and the method of multicasting a file starting from the data being transmitted to the first user device at the time point when another user device requests the same file should perform multicast by utilizing other resources such as time, frequency and the like, but the wireless resources are limited. That is, a user should not be kept waiting for a long time, and the resources such as frequency, power and the like are limited.

In addition, it is not always that multicast is unconditionally more effective than unicast. There are cases in which the unicast is advantageous or the multicast is advantageous depending on situations.

Accordingly, a communication technique is required to transmit a file on the basis of a proper combination of unicast and multicast depending on situations when a plurality of user devices requests the same file at different time points.

Korean Laid-opened Patent No. 10-2010-0114014 relates to a method of determining a time point of multicasting a real-time streaming interactive video, and it proposes a configuration of multicasting a streaming interactive video/audio stream to a plurality of destinations by a server center using an outbound Internet traffic interface as a medium.

### SUMMARY OF THE INVENTION

The present invention relates to a communication technique which can efficiently multicast a file when two or more user devices request the same file at different time points.

In addition, the present invention relates to a technique of transmitting, by a base station utilizing limited wireless resources, a requested file to a plurality of user devices in a minimum time through a combination of multicast and unicast.

To accomplish the above objects, there is provided a method of multicasting data to a plurality of user devices belonging to a base station, and the method may include: receiving a request for transmitting a file from user device 1 belonging to the base station; unicasting the requested file to the user device 1; receiving a request for transmitting the file unicast to the user device 1 from user device 2 belonging to the base station; and switching to multicast and multicasting the file after unicasting the file to the user device 1 and the user device 2 for a certain time.

According to an aspect, switching to multicast and multicasting the file may include unicasting the file to each of the user device 1 and the user device 2 until a time point when a cumulative transmission amount of the file transmitted to the user device 1 becomes equal to a cumulative transmission amount of the file transmitted to the user device 2.

According to another aspect, switching to multicast and multicasting the file may include multicasting the file to the user device 1 and the user device 2 simultaneously from a time point when a cumulative transmission amount of the file transmitted to the user device 1 becomes equal to a cumulative transmission amount of the file transmitted to the user device 2.

According to still another aspect, switching to multicast and multicasting the file may include adjusting a transmission amount of the file unicast to each of the user device 1 and the user device 2 on the basis of a magnitude of a channel allocated to the user device 1 and a magnitude of a channel allocated to the user device 2 to make a cumulative transmission amount of the user device 1 and a cumulative transmission amount of the user device 2 related to the file equal to each other.

According to still another aspect, adjusting a transmission amount may include: determining, when the magnitude of the channel of the user device 1 is larger than the magnitude of the channel of the user device 2, a transmission rate R₂⁽⁴⁾ of a point where a transmission amount per second of the user device 2 is a maximum in a F(P3) area as a transmission rate of the user device 2; and determining a transmission rate R₁⁽⁴⁾ of a point corresponding to a transmission amount per second of the user device 1, corresponding to the transmission rate R₂⁽⁴⁾ of a point where the transmission amount per second of the user device 2 is a maximum in the F(P3) area, as a transmission rate of the user device 1.

According to still another aspect, adjusting a transmission amount may include: determining, when the magnitude of the channel of the user device 1 is smaller than or equal to the magnitude of the channel of the user device 2 and a point where a transmission amount per second of the user device 2 is a minimum becomes an optimal solution, a transmission rate R₂⁽³⁾ of a point where the transmission amount per second of the user device 2 is a minimum in a F(P3) area as a transmission rate of the user device 2; and determining a transmission rate R₁⁽³⁾ of a point corresponding to a transmission amount per second of the user device 1, corresponding to the transmission rate R₂⁽³⁾ of a point where the transmission amount per second of the user device 2 is a minimum in the F(P3) area, as a transmission rate of the user device 1.

According to still another aspect, adjusting a transmission amount may include: determining, when the magnitude of the channel of the user device 1 is smaller than or equal to the magnitude of the channel of the user device 2 and a point where a transmission amount per second of the user device 2 is a maximum becomes an optimal solution, a transmission rate R₂⁽⁴⁾ of a point where the transmission amount per second of the user device 2 is a maximum in a F(P3) area as a transmission rate of the user device 2; and determining a transmission rate R₁⁽⁴⁾ of a point corresponding to a transmission amount per second of the user device 1, corresponding to the transmission rate R₂⁽⁴⁾ of a point where the transmission amount per second of the user device 2 is a maximum in the F(P3) area, as a transmission rate of the user device 1.

According to still another aspect, adjusting a transmission amount may further include unicasting the file to each of the user device 1 and the user device 2 for the certain time at the determined transmission rates of the user device 1 and the user device 2.

According to still another aspect, the file may be hybridcast by dividing a transmission period into a first period between a time point of beginning unicast of the file to the user device 1 and a time point of beginning unicast of the file to the user device 2, a second period between a time point of beginning unicast of the file to the user device 2 and a time point of beginning multicast of the file to the user device 1 and the user device 2, and a third period between a time point of beginning multicast of the file and a time point of completing transmission of the file.

According to still another aspect, switching to multicast and multicasting the file may include switching the unicast transmission to the multicast transmission when the transmission amount of the file transmitted to the user device 1 during the first period and the second period becomes equal to the transmission amount of the file transmitted to the user device 2 during the second period.

A multicast system for multicasting data to a plurality of user devices may include a file request reception unit for receiving a request for transmitting a file from user device 1 belonging to the multicast transmission system and receiving a request for transmitting the file requested by the user device 1 from user device 2 after receiving the request for transmitting the file from the user device 1; and a transmission control unit for unicasting the file requested by the user device 1 to the user device 1 and switching to multicast and transmitting the file after unicasting the file to the user device 1 and the user device 2 for a certain time from a time point of receiving the request for transmitting the file from the user device 2.

According to an aspect, the transmission control unit may include a unicast control unit for unicasting the file to each of the user device 1 and the user device 2 until a time point when a cumulative transmission amount of the file transmitted to the user device 1 becomes equal to a cumulative transmission amount of the file transmitted to the user device 2.

According to another aspect, the transmission control unit may include a multicast control unit for multicasting the file to the user device 1 and the user device 2 simultaneously from a time point when a cumulative transmission amount of the file transmitted to the user device 1 becomes equal to a cumulative transmission amount of the file transmitted to the user device 2.

According to still another aspect, the transmission control unit may include a transmission amount adjustment unit for adjusting a transmission amount of the file unicast to each of the user device 1 and the user device 2 on the basis of a magnitude of a channel allocated to the user device 1 and a magnitude of a channel allocated to the user device 2 to make a cumulative transmission amount of the user device 1 and a cumulative transmission amount of the user device 2 related to the file equal to each other.

According to still another aspect, the transmission control unit may determine, when the magnitude of the channel of the user device 1 is larger than the magnitude of the channel of the user device 2, a transmission rate R₂⁽⁴⁾ of a point where a transmission amount per second of the user device 2 is a maximum in a F(P3) area as a transmission rate of the user device 2; and determine a transmission rate R₁⁽⁴⁾ of a point corresponding to a transmission amount per second of the user device 1, corresponding to the transmission rate R₂⁽⁴⁾ of a point where the transmission amount per second of the user device 2 is a maximum in the F(P3) area, as a transmission rate of the user device 1.

According to still another aspect, the transmission control unit may determine, when the magnitude of the channel of the user device 1 is smaller than or equal to the magnitude of the channel of the user device 2 and a point where a transmission amount per second of the user device 2 is a minimum becomes an optimal solution, a transmission rate R₂⁽³⁾ of a point where the transmission amount per second of the user device 2 is a minimum in a F(P3) area as a transmission rate of the user device 2; and determine a transmission rate R₁⁽³⁾ of a point corresponding to a transmission amount per second of the user device 1, corresponding to the transmission rate R₂⁽³⁾ of a point where the transmission amount per second of the user device 2 is a minimum in the F(P3) area, as a transmission rate of the user device 1.

According to still another aspect, the transmission control unit may determine, when the magnitude of the channel of the user device 1 is smaller than or equal to the magnitude of the channel of the user device 2 and a point where a transmission amount per second of the user device 2 is a maximum becomes an optimal solution, a transmission rate R₂⁽⁴⁾ of a point where the transmission amount per second of the user device 2 is a maximum in a F(P3) area as a transmission rate of the user device 2; and determine a transmission rate R₁⁽⁴⁾ of a point corresponding to a transmission amount per second of the user device 1, corresponding to the transmission rate R₂⁽⁴⁾ of a point where the transmission amount per second of the user device 2 is a maximum in the F(P3) area, as a transmission rate of the user device 1.

According to still another aspect, the file may be unicast to each of the user device 1 and the user device 2 for the certain time at the determined transmission rates of the user device 1 and the user device 2.

According to still another aspect, the file may be hybridcast by dividing a transmission period into a first period between a time point of beginning unicast of the file to the user device 1 and a time point of beginning unicast of the file to the user device 2, a second period between a time point of beginning unicast of the file to the user device 2 and a time point of beginning multicast of the file to the user device 1 and the user device 2, and a third period between a time point of beginning multicast of the file and a time point of completing transmission of the file.

According to still another aspect, the transmission control unit may unicast data of different parts configuring the file to each of the user device 1 and the user device 2 from a time point of receiving the request for transmitting a file from the user device 2, and multicast data of the same part configuring the file to the user device 1 and the user device 2 after a certain time is elapsed.

A multicast transmission method performed by a base station may include: receiving, by a file request reception unit, a request for transmitting a file from a first user device at a first time point; receiving, by the file request reception unit, a request for transmitting the file from a second user device at a second time point after receiving the request for transmitting the file from the first user device; transmitting, by a unicast control unit, the file to the first user device in a first period between the first time point and the second time point; transmitting, by the unicast control unit, the file to each of the first user device and the second user device via unicast transmission in a second period between the second time point and a third time point when a transmission amount of the file transmitted to the first user device becomes equal to a transmission amount of the file transmitted to the second user device; and transmitting, by a multicast control unit, the file to the first user device and the second user device via multicast transmission from the third time point.

According to an aspect, the method may further include: adjusting, by a transmission amount adjustment unit, a transmission rate of the first user device and a transmission rate of the second user device in the second period to minimize a completion time of a transmission of the file to the first user device and the second user device.

According to another aspect, adjusting the transmission rate of the first user device and the transmission rate of the second user device in the second period may include: adjusting the transmission rate of the first user device and the transmission rate of the second user device on the basis of a channel between the first user device and the base station and a channel between the second user device and the base station

According to still another aspect, adjusting the transmission rate of the first user device and the transmission rate of the second user device in the second period may include: adjusting the transmission rate of the first user device and the transmission rate of the second user device to meet a first condition that an average transmission rate of the first user device in a period between the first time point and the third time point is greater than or equal to the minimum transmission rate for stable playback of the file, and a second condition that the transmission rates of the first user device and the second user device in the second period are included in available combinations of transmission rates of the base station.

According to still another aspect, adjusting the transmission rate of the first user device and the transmission rate of the second user device in the second period may include: when a magnitude of the channel of the first user device is greater than a magnitude of the channel of the second user device, adjusting the transmission rate of the second user device to a maximum value that meets the first condition and the second condition.

According to still another aspect, adjusting the transmission rate of the first user device and the transmission rate of the second user device in the second period may include: adjusting the transmission rate of the second user device to a maximum transmission rate for the second user device according to a transmission power of the base station.

According to still another aspect, adjusting the transmission rate of the first user device and the transmission rate of the second user device in the second period may include: adjusting the transmission rate of the second user device to a transmission rate of the second user device at an intersection point between a boundary of the first condition and a boundary of the second condition.

According to still another aspect, adjusting the transmission rate of the first user device and the transmission rate of the second user device in the second period may include: when a magnitude of the channel of the first user device is smaller than or equal to a magnitude of the channel of the second user device and the completion time of the transmission of the file to the first user device and the second user device is a decreasing function of a transmission power for the second user device at a point where the transmission rate of the second user device is a maximum value that meets the first condition and the second condition, adjusting the transmission rate of the second user device to the maximum value that meets the first condition and the second condition.

According to still another aspect, adjusting the transmission rate of the first user device and the transmission rate of the second user device in the second period may include: adjusting the transmission rate of the second user device to a maximum transmission rate for the second user device according to a transmission power of the base station.

According to still another aspect, adjusting the transmission rate of the first user device and the transmission rate of the second user device in the second period may include: adjusting the transmission rate of the second user device to a transmission rate of the second user device at an intersection point between a boundary of the first condition and a boundary of the second condition.

According to still another aspect, adjusting the transmission rate of the first user device and the transmission rate of the second user device in the second period incl may include udes: when a magnitude of the channel of the first user device is smaller than or equal to a magnitude of the channel of the second user device and the completion time of the transmission of the file to the first user device and the second user device is not a decreasing function of a transmission power for the second user device at a point where the transmission rate of the second user device is a maximum value that meets the first condition and the second condition, adjusting the transmission rate of the second user device to

$$( {log}_{2} ( 1 + \frac{{\vert {h}_{2} \vert}^{2} ( P - {P}_{2}^{′} )}{1 + {\vert {h}_{1} \vert}^{2} {P}_{2}^{′}} ) , {log}_{2} ( 1 + {\vert {h}_{2} \vert}^{2} {P}_{2}^{′} ) ) ,$$

wherein h₁ is a channel between the first user device and the base station, h₂ is a channel between the second user device and the base station, and P₂′ is a transmission power for the second user device at a point where the completion time of the transmission of the file to the first user device and the second user device changes from a decreasing function of the transmission power for the second user device to an increasing function of the transmission power for the second user device.

A multicast transmission system including a base station, may include: a file request reception unit for receiving a request for transmitting a file from a first user device at a first time point, and receiving a request for transmitting the file from a second user device at a second time point after receiving the request for transmitting the file from the first user device; a unicast control unit for transmitting the file to the first user device in a first period between the first time point and the second time point, and transmitting the file to each of the first user device and the second user device via unicast transmission in a second period between the second time point and a third time point when a transmission amount of the file transmitted to the first user device becomes equal to a transmission amount of the file transmitted to the second user device; and a multicast control unit for transmitting the file to the first user device and the second user device via multicast transmission from the third time point.

According to an aspect, the system may further include: a transmission amount adjustment unit for adjusting a transmission rate of the first user device and a transmission rate of the second user device in the second period to minimize a completion time of a transmission of the file to the first user device and the second user device.

According to another aspect, the transmission amount adjustment unit may adjust the transmission rate of the first user device and the transmission rate of the second user device on the basis of a channel between the first user device and the base station and a channel between the second user device and the base station

According to still another aspect, the transmission amount adjustment unit may adjust the transmission rate of the first user device and the transmission rate of the second user device to meet a first condition that an average transmission rate of the first user device in a period between the first time point and the third time point is greater than or equal to the minimum transmission rate for stable playback of the file, and a second condition that the transmission rates of the first user device and the second user device in the second period are included in available combinations of transmission rates of the base station.

According to still another aspect, the transmission amount adjustment unit may adjust, when a magnitude of the channel of the first user device is greater than a magnitude of the channel of the second user device, the transmission rate of the second user device to a maximum value that meets the first condition and the second condition.

According to still another aspect, the transmission amount adjustment unit may adjust the transmission rate of the second user device to a transmission rate of the second user device at an intersection point between a boundary of the first condition and a boundary of the second condition.

According to still another aspect, the transmission amount adjustment unit may adjust, when a magnitude of the channel of the first user device is smaller than or equal to a magnitude of the channel of the second user device and the completion time of the transmission of the file to the first user device and the second user device is a decreasing function of a transmission power for the second user device at a point where the transmission rate of the second user device is a maximum value that meets the first condition and the second condition, the transmission rate of the second user device to the maximum value that meets the first condition and the second condition.

According to still another aspect, the transmission amount adjustment unit may adjust, when a magnitude of the channel of the first user device is smaller than or equal to a magnitude of the channel of the second user device and the completion time of the transmission of the file to the first user device and the second user device is not a decreasing function of a transmission power for the second user device at a point where the transmission rate of the second user device is a maximum value that meets the first condition and the second condition, the transmission rate of the second user device to

$$( {log}_{2} ( 1 + \frac{{\vert {h}_{2} \vert}^{2} ( P - {P}_{2}^{′} )}{1 + {\vert {h}_{1} \vert}^{2} {P}_{2}^{′}} ) , {log}_{2} ( 1 + {\vert {h}_{2} \vert}^{2} {P}_{2}^{′} ) ) ,$$

wherein h₁ is a channel between the first user device and the base station, h₂ is a channel between the second user device and the base station, and P₂′ is a transmission power for the second user device at a point where the completion time of the transmission of the file to the first user device and the second user device changes from a decreasing function of the transmission power for the second user device to an increasing function of the transmission power for the second user device.

The present invention includes a computer-readable recording medium recording a program for executing a method according to an embodiment of the present invention in a computer.

### BRIEF DESCRIPTION OF THE DRAWINGS

FIG. 1 is a view showing a wireless network environment configured of user devices and a base station in an embodiment of the present invention.

FIG. 2 is a block diagram showing the internal configuration of a multicast transmission system in an embodiment of the invention.

FIG. 3 is a flowchart illustrating a multicast transmission method in an embodiment of the invention.

FIG. 4 is a flowchart illustrating the operation of transmitting a file by combining unicast and multicast transmissions on the basis of cumulative transmission amounts of a file in an embodiment of the invention.

FIG. 5 is a graph provided to explain the operation of adjusting a transmission amount in a second period in an embodiment of the invention.

### DETAILED DESCRIPTION OF THE PREFERRED EMBODIMENT

Hereafter, embodiments of the present invention will be described in detail with reference to the accompanying drawings.

The present invention relates to a technique of dividing a file transmission period into a plurality of periods and transmitting a file in a method of hybridcast combining unicast and multicast when two or more user devices request the same file at different time points. Particularly, the present invention relates to a technique targeting user devices requesting the same file at different time points to multicast a file to user device 1 and user device 2 after adjusting transmission amounts to make cumulative transmission amounts of the corresponding file equal to each other in the user device 1 and the user device 2 from the time point of requesting the same file by the user device 2 after the user device 1 requests the file. That is, the present invention relates to a technique of transmitting a file in the form of combining unicast and multicast in each transmission period according to the magnitude of a wireless channel between a base station and user devices to minimize the time required to transmit the file by the base station to the user devices that have requested the same file at different time points,

In the embodiments, a multicast transmission system corresponds to a base station, and there may be two or more user devices belonging to the multicast transmission system. In the embodiments, a network environment in which two user devices are served by one base station may be assumed.

In the embodiments, a ‘transmission period’ may be divided into a first period between a time point of beginning unicast of a file to the user device 1 and a time point of beginning unicast of the file to the user device 2, a second period between a time point of beginning unicast of the file to the user device 2 and a time point of beginning multicast of the file to the user device 1 and the user device 2, and a third period between a time point of beginning multicast of the file to the user device 1 and the user device 2 and a time point of completing transmission of the file. The time point of beginning the multicast in the second period may be a time point when the cumulative file transmission amount of the user device 1 becomes equal to the cumulative file transmission amount of the user device 2.

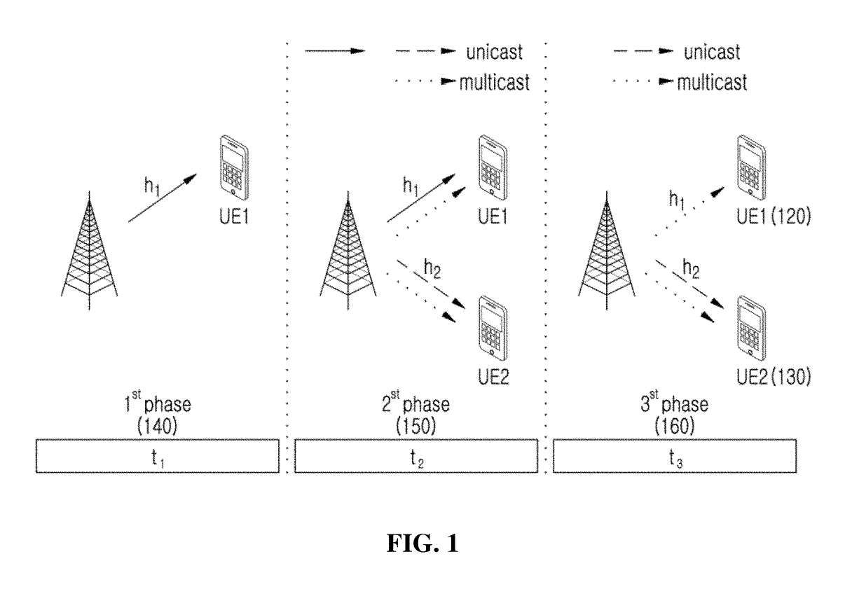

FIG. 1 is a view showing a wireless network environment configured of user devices and a base station in an embodiment of the present invention.

According to FIG. 1, one base station 110 (i.e., a multicast transmission system) and two user devices 120 and 130 may configure a network, and channels h1 and h2 may be formed between the base station 110 and the two user devices 120 and 130, respectively. In FIG. 1, a transmission period for transmitting a file from the base station 110 to the user devices 120 and 130 may include a first period 140, a second period 150, and a third period 160. In addition, it is assumed that after user device 1 120 requests a file first, user device 2 130 requests a file the same as the file requested by the user device 1 120. That is, it is assumed that after time t1 is elapsed from the time point of requesting the file from the base station 110 by the user device 1 120, the user device 2 130 requests the same file from the base station 110.

At a first step (i.e., in the first period 140), since only the user device 1 120 requests the file, the base station 110 may unicasts the requested file to the user device 1 120. At this point, since only the user device 1 120 has requested transmission of the file from the base station 110 and the user device 2 130 does not request transmission of the file yet, the base station 110 may unicast the file to the user device 1 120 with full power (i.e., at a predetermined maximum power).

At a second step (i.e., in the second period 150), when the user device 2 130 requests the base station 110 to transmit a file the same as the file transmitted to the user device 1 120, the base station 110 may transmit the file to both of the user device 1 120 and the user device 2 130. At this point, the base station 110 may unicast the file to each of the user device 1 120 and the user device 2 130. For example, the base station may transmit the file by adjusting target transmission amounts (i.e., adjusting the transmission power) to make the cumulative transmission amount of the file transmitted to the user device 1 120 and the cumulative transmission amount of the file transmitted to the user device 2 130 equal to each other to take advantage of multicast in the third period 160.

At a third step (i.e., in the third period 160), the base station 110 may multicast the file to the user device 1 120 and the user device 2 130. That is, since the cumulative transmission amounts of the file transmitted to the user device 1 120 and the user device 2 130 are equal to each other, the base station 110 may simultaneously transmit the same part of the file to the two user devices 120 and 130. Like this, as the file is multicast to the two user devices 120 and 130 after the cumulative transmission amounts are adjusted to be equal to each other, the time required to transmit the entire file to the two user devices 120 and 130 can be minimized.

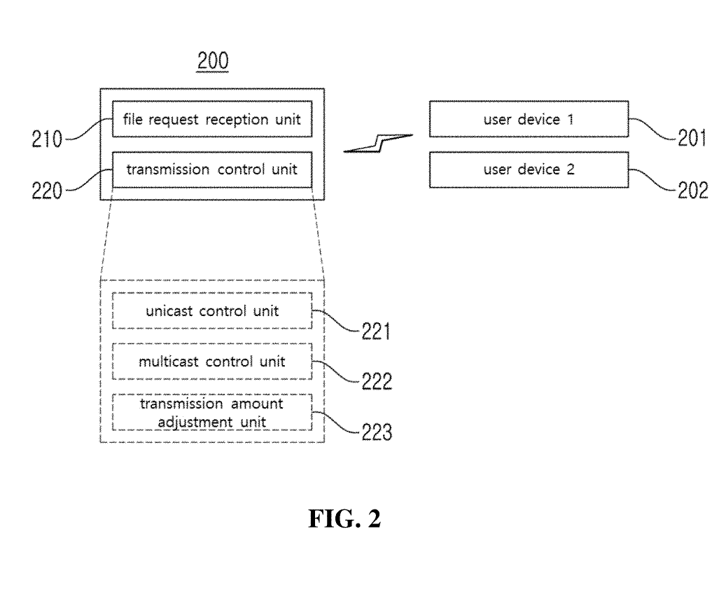

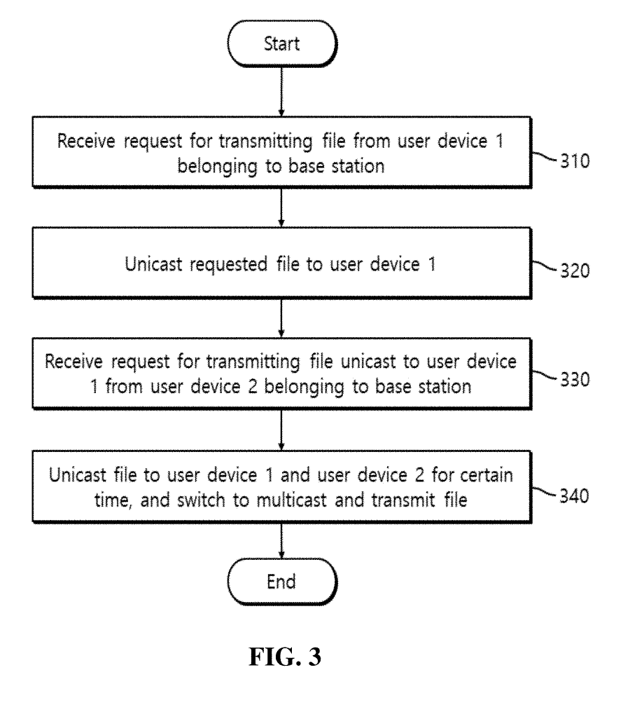

FIG. 2 is a block diagram showing the internal configuration of a multicast transmission system in an embodiment of the invention, and FIG. 3 is a flowchart illustrating a multicast transmission method in an embodiment of the invention.

According to FIG. 2, a multicast transmission system 200 may include a file request reception unit 210 and a transmission control unit 220, and the transmission control unit 220 may include a unicast control unit 221, a multicast control unit 222 and a transmission amount adjustment unit 223. In FIG. 2, a network environment configured of two user devices 201 and 202 belonging to the multicast transmission system 200, which is a base station, is assumed.

In FIG. 3, each of the steps (steps 310 to 340) may be performed by the file request reception unit 210 and the transmission control unit 220, which are constitutional components of the multicast transmission system 200 shown in FIG. 2.

At step 310, the file request reception unit 210 may receive a request for transmitting a file from user device 1 201 belonging to the multicast transmission system 200, which is a base station. For example, the file request reception unit 210 may receive a request for transmitting a file of which a video streaming service is desired to be received by the user device 1.

At step 320, the unicast control unit 221 may unicast the file requested by the user device 1 201 to the user device 1 201.

For example, in a network environment including two user devices of user device 1 and user device 2 belonging to the base station, if only the user device 1 201, excluding the user device 2 202, requests transmission of a file, the unicast control unit 221 may unicast the file to the user device 1 201 at a predetermined its own maximum power.

That is, the unicast control unit 221 may unicast the file to the user device 1 201 at a maximum power in the first period between the time point of receiving the request for transmitting the file from the user device 1 201 and the time point of receiving a request for transmitting a file the same as that of the user device 1 201 from the user device 2 202.

At step 330, the file request reception unit 210 may receive a request for transmitting the file being unicast to the user device 1 201 from the user device 2 202. That is, a request for transmitting a file the same as the file being unicast to the user device 1 201 may be received from the user device 2 202 at a time point different from that of the user device 1 201.

At step 340, the transmission control unit 220 may switches to multicast and transmit a corresponding file after unicasting the file to the user device 1 201 and the user device 2 202 for a certain time.

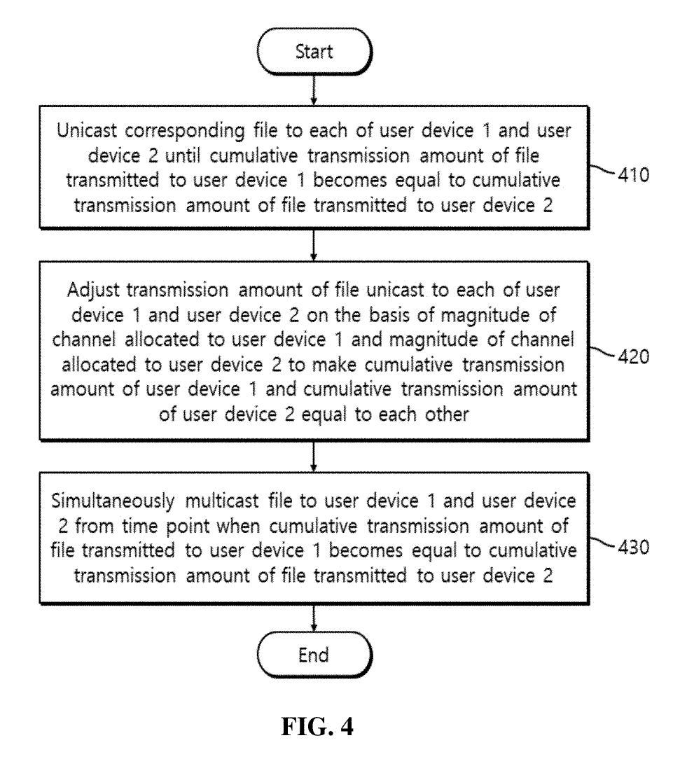

Here, the certain time may be a time between the time point of requesting the file by the user device 1 201 and the time point when the cumulative transmission amount of the file transmitted to the user device 1 201 becomes equal to the cumulative transmission amount of the file transmitted to the user device 2 202. That is, the certain time may be a time corresponding to the second period. The detailed operation of switching to multicast while unicasting a file and transmitting the file will be described with reference to FIG. 4.

FIG. 4 is a flowchart illustrating the operation of transmitting a file by combining unicast and multicast transmissions on the basis of cumulative transmission amounts of a file in an embodiment of the invention.

In FIG. 4, each of the steps (steps 410 to 430) may be performed by the transmission control unit 220 of FIG. 2.

At step 410, the unicast control unit 221 may unicast a file to each of the user device 1 201 and the user device 2 202 until a time point when the cumulative transmission amount of the file transmitted to the user device 1 201 becomes equal to the cumulative transmission amount of the file transmitted to the user device 2 202 (that is, during the second period corresponding to the certain time).

For example, when a file the same as the file being transmitted to the user device 1 201 is requested by the user device 2 202, the user device 1 201 may have more data since the user device 1 201 has requested the file before the user device 2 202 in the first period. Accordingly, although the user device 2 202 requests transmission of the same file, a file portion for the user device 1 201 may be different form a file portion for the user device 2 202 when the same file is transmitted to the user device 1 201 and the user device 2 202. Accordingly, although the file is the same, the unicast control unit 221 may unicast different data portions of the corresponding file to each of the user device 1 201 and the user device 2 202 until the cumulative transmission amount of the user device 1 201 becomes equal to the cumulative transmission amount of the user device 2 202.

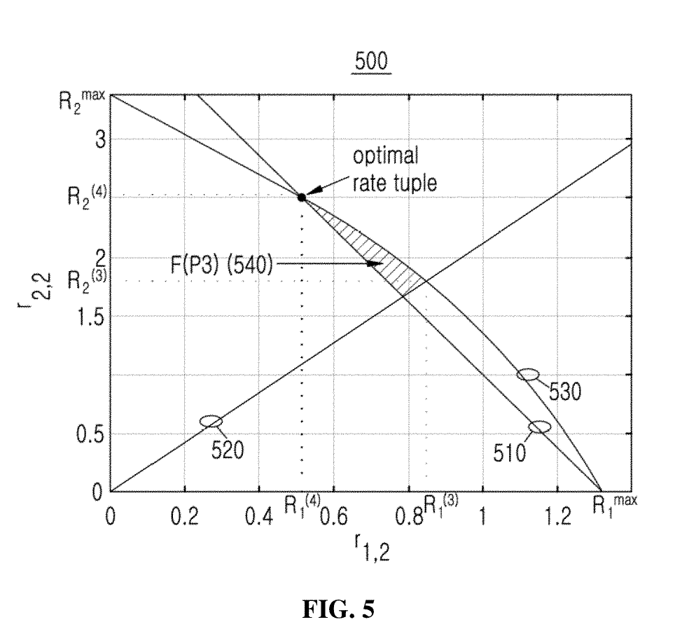

At this point, at step 420, to make the cumulative transmission amount of the user device 1 201 and the cumulative transmission amount of the user device 2 202 equal to each other, the transmission amount adjustment unit 223 may adjust the transmission amount of the file unicast to each of the user devices 201 and 202 on the basis of the magnitude of the wireless channel allocated between each of the user device 1 201 and the user device 2 202 and the base station during the second period. Here, the operation of adjusting the transmission amount of a file will be described in detail with reference to FIG. 5.

At step 430, the multicast control unit 222 may simultaneously multicast the file to the user device 1 201 and the user device 2 202 from the time point when the cumulative transmission amount of the file transmitted to the user device 1 201 becomes equal to the cumulative transmission amount of the file transmitted to the user device 2 202. That is, the uncast transmission may be switched to multicast transmission.

For example, if the transmission amount of the file transmitted to the user device 1 201 during the first period and the second period becomes equal to the transmission amount of the file transmitted to the user device 2 202 during the second period, the multicast control unit 222 may simultaneously multicast the same data portion of the file to the user device 1 201 and the user device 2 202 during the third period.

Like this, the problem of minimizing the time required to transmit the entire file to the user device 1 201 and the user device 2 202 can be defined as shown in equation 1.

$${T}^{HC} = {min}_{{r}_{1 , 2} , {r}_{2 , 2} , {t}_{2} , {t}_{3}} {t}_{1} + {t}_{2} + {t}_{3} \\ \begin{matrix}s . t . & {I}_{2 , 2} = {I}_{1 , 1} + {I}_{1 , 2 ,} & condition 1 \\ & {I}_{1 , 1} + {I}_{1 , 2} \geq {R}_{pb} ( {t}_{1} + {t}_{2} ) , & condition 2 \\ & {I}_{1 , 1} + {I}_{1 , 2} + {I}_{1 , 3} = Γ , & condition 3 \\ & {r}_{2 , 2} \geq {R}_{pb} , & condition 4 \\ & ( {r}_{1 , 2} , {r}_{2 , 2} ) {ϵC}_{BC} ( P ) & condition 5\end{matrix} \qquad [ Equation 1 ]$$

In equation 1, t₁ denotes a duration time corresponding to the first period, t₂ denotes a duration time corresponding to the second period, t₃ denotes a duration time corresponding to the third period, I_{1,1}, denotes a total data amount that the user device 1 receives in the first period, I_{1,2} denotes a total data amount that the user device 1 receives in the second period, I_{2,2} denotes a total data amount that the user device 2 receives in the second period, I_{1,3} denotes a total data amount that the user device 1 receives in the third period, r_{1,2} denotes a transmission amount per second (i.e., a transmission rate) of the user device 1 in the second period, r_{2,2} denotes a transmission amount per second (i.e., a transmission rate) of the user device 2 in the second period. Further, R_{pb} denotes a minimum transmission amount per second required to stably play back a file requested by the user device 1 and the user device 2 (e.g., to play back a video stream without disruption), Γ denotes a total amount of data of a file requested by the user device 1 and the user device 2, and C_{BC}(P) denotes a set of transmission amounts per second that can be accomplished by a wireless channel including one transmitter and two receivers (i.e., one base station and two user devices) with transmit power P. T^{HC} means the completion time of the transmission of the file to the user device 1 and the user device 2.

In the first period, if the amount of data transmitted per second by the multicast transmission system 200, which is a base station, to the user device 1 201 is r_{1,1}, the amount of data received by the user device 1 201 before the user device 2 202 requests the file (i.e., data) may be expressed as shown in equation 2.

I_{1,1}=r_{1,1}t₁ [Equation 2]

If the transmission power of the base station is P and the wireless channel between the base station and the user device 1 201 is h₁, the maximum value of r_{1,1} expressed in equation 2 may be expressed as shown in equation 3.

R₁^{max}=log₂(1+|h₁|²P) [Equation 3]

According to equation 3, since only the user device 1 201 is served by the multicast transmission system 200 until the user device 2 202 requests a file from the multicast transmission system 200, which is a base station, the entire power can be allocated (i.e., concentrated) to transmit the file to the user device 1 201. Accordingly, r_{1,1} may have a maximum value (i.e., maximum power).

In the same manner as in the first period, the amount of data received by each user device from the base station in the second period may be expressed as shown in equation 4 and equation 5, and multicast transmission to the user device 1 and the user device 2 in the third period may be expressed as shown in equation 6.

I_{1,2}=r_{1,2}t₂ [Equation 4]

I_{2,2}=r_{2,2}t₂ [Equation 5]

I_{1,3}=I_{2,3} [Equation 6]

Based on the equations 4 to 6, the meaning of each condition of the problem (i.e., condition 1 to condition 5 of equation 1) may be as described below. Condition 1 may mean that the amount of data received by the user device 1 201 from the base station in the first period and the second period should be equal to the amount of data received by the user device 2 202 in the second period. That is, it may correspond to a condition for multicasting in the third period.

Condition 2 and condition 4 of equation 1 may mean that the transmission amount of wireless information per second should be larger than or equal to the playback rate for stable playback of the file in each user device. That is, condition 2 is a condition for the user device 1 201 when the base station unicasts a file to the user device 1 201 during the second period, and condition 4 may be a condition for the user device 2 202 when the base station unicasts a file to the user device 2 202 during the second period. Here, since an effect is generated by the transmission in the first period as the user device 1 201 requests a file first in the first period, the conditions of the user device 1 201 and the user device 2 202 may be different from each other as shown in condition 2 and condition 4 of equation 1.

In equation 1, condition 3 may express that the user device 1 201 should receive all the data of the requested file through the first period, the second period, and the third period. In addition, condition 3 may express that also the user device 2 202 should receive all the data of the file in combination of condition 1.

In equation 1, condition 5 may express that when a transmission per second service is simultaneously provided to a plurality of user devices (e.g., user device 1 and user device 2), transmission rates of the user devices should be determined as a combination of transmission rates that can be accomplished by the base station since unicast transmission is performed in the second period. That is, in the second period, a combination of transmission rates of two user devices that can be selected by the base station may be selected from a set of transmission rates that can be accomplished in a wireless channel including one transmitter and two receivers.

Table 1 shown below may express the conditions for existence of solution for determining proper transmission rates according to the magnitude of a wireless channel, in adjusting the transmission rates to make the cumulative transmission amounts equal to each other among the user devices in the second period.

TABLE 1
Proposition 3: Hybridcast based transmission guarantees the playback rate
constraint if and only if P is greater than or equal to Pₜₕ^{HC}, which is given
by
[Equation 7]
${P}_{th}^{HC} = \{ \begin{matrix}{P}_{th}^{HC , 1} , & if \vert {h}_{1} \vert \leq \vert {h}_{2} \vert \\ {P}_{th}^{HC , 2} , & otherwise\end{matrix}$
where
[Equation 8]
${P}_{th}^{HC , 1} = \frac{{2}^{{R}_{pb}}}{ {\vert {h}_{1} \vert}^{2}} {( 1 + \frac{ {\vert {h}_{1} \vert}^{2} ( {2}^{\frac{Γ {R}_{pb}}{Γ - {t}_{1} {R}_{pb}}} - 1 )}{{\vert {h}_{2} \vert}^{2}} )}^{\frac{Γ - {t}_{1} {R}_{pb}}{Γ}} - \frac{1}{ {\vert {h}_{1} \vert}^{2}}$
and Pₜₕ^{HC,2} is the unique root of following function:
[Equation 9]
${f}_{4} ( x ) = {log}_{2} ( 1 + \frac{{\vert {h}_{1} \vert}^{2}}{{\vert {h}_{2} \vert}^{2}} ( \frac{ 1 + {\vert {h}_{2} \vert}^{2} x}{{2}^{\frac{Γ {R}_{pb}}{Γ - {t}_{1} {R}_{pb}}}} - 1 ) ) + \frac{( {t}_{1} {log}_{2} ( 1 + {\vert {h}_{1} \vert}^{2} x ) - Γ ) {R}_{pb}}{Γ - {t}_{1} {R}_{pb}}$

A minimum power of the base station required for existence of a solution of the problem expressed as shown in equation 1 may be expressed as shown in equation 7. Then, to solve the problem of equation 1 on the basis of the condition of an optimal solution, equation 1 may be expressed as shown in equation 10.

$${T}^{HC} = {min}_{{r}_{1 , 2} , {r}_{2 , 2}} \frac{min ( {R}_{1}^{max} , {R}_{2}^{max} ) - {r}_{2 , 2}}{{r}_{2 , 2} - {r}_{1 , 2}} \\ \begin{matrix}s . t . & {r}_{1 , 2} + ( \frac{{R}_{1}^{max}}{{R}_{pb}} - 1 ) {r}_{2 , 2} \geq {R}_{1}^{max} , & condition 1 \\ & {Γ}_{1 , 2} - ( Γ - {I}_{1 , 1} ) {r}_{2 , 2} \leq 0 , & condition 2 \\ & ( {r}_{1 , 2} , {r}_{2 , 2} ) {ϵC}_{BC} ( P ) , & condition 3\end{matrix} \qquad [ Equation 10 ]$$

Condition 1 of equation 10 may express a condition combining a condition that the total amount of data received by the user device 2 in the second period should be equal to the total amount of data received by the user device 1 in the first period and the second period (i.e., condition 1 of equation 1) and a condition that the average transmission rate of data of the user device 1 (a data transmission amount of the first period and the second period/a time corresponding to the first period and the second period) should be greater than or equal to the minimum transmission amount per second (Rₚb) (i.e., condition 2 of equation 1). That is, the physical meaning of condition 1 may express a condition that the transmission amounts per second (transmission rates) of the user device 1 and the user device 2 in the second period should meet, to make the average transmission rate of the user device 1 greater than or equal to the minimum playback rate when the same amount of data has been received by the user device 1 and 2, i.e., when the second period is terminated, as the user device 1 receives data in the maximum rate in the first period.

Condition 2 of equation 10 may be induced as described below. First, the time of the third period may be calculated by associating condition 3 of equation 1 (i.e., a sum of data of the first, second, and third periods should be equal to the volume of a requested file) and condition 2 of equation 1 (i.e., a condition that an average transmission amount is larger than a minimum transmission amount). Then, if an inequality that a physical time should be always greater than or equal to zero is applied, condition 2 of equation 10 may be derived. The physical meaning of condition 2 of equation 10 may express a condition that the transmission amounts per second (transmission rates) of the user device 1 and the user device 2 of the second period should meet, to make the amount of data received by the user device 1 or 2 smaller than or equal to the total amount of data of the requested file when the same amount of data has been received by the user device 1 and 2, i.e., when the second period is terminated.

Equation 10 described above shows a problem of determining a combination of transmission rates of the user device 1 201 and the user device 2 202 in the second period, and since a problem expressed as shown in equation 10 is a problem of finding a point which minimizes a target function on a two-dimensional plane, it may be expressed as a graph shown in FIG. 5. In equation 10, C_{BC}(P) denotes a collection (i.e., a set) of two dimensional points having transmission rates of the user device 1 and the user device 2 configured in pairs as elements, and for example, two dimensional points such as r₁, r₂ and the like may be included.

FIG. 5 is a graph provided to explain the operation of adjusting a transmission amount in a second period in an embodiment of the invention.

The graph 500 of FIG. 5 may include lines configured on the basis of condition 1 510 of equation 10, condition 2 520 of equation 10, and condition 3 530 of equation 10. A set of points satisfying all of conditions 1 to 3 of equation 10 may be expressed as an area 540 of F(P3). Here, the area 540 of F(P3) may express a set of transmission rate pairs satisfying C_{BC}(P), condition 1 510, and condition 2 520 of equation 10, i.e., a set of (r_{1,2}, r_{2,2}) satisfying condition 1 510, condition 2 520, and condition 3 530 of equation 10. In F(P3), P3 may represent a problem expressed as shown in equation 10. That is, the F(P3) area may express a set of points having transmission rates of the user device 1 and the user device 2 in the second period as a pair satisfying all of condition 1 510 that the average transmission rate of the user device 1 in the first and second periods is greater than or equal to the minimum playback rate, condition 2 520 that the amount of data transmitted to each of the user device in the first and second periods is equal or smaller than the total amount of the file, and condition 3 530 that the transmission rate of the user device 1 and the transmission rate of the user device 2 in the second period should be included in C_{BC}(P), which is a set of two dimensional points having transmission rates of the user device 1 and the user device 2 as elements.

At this point, in the problem of determining a combination of transmission rates of the user device 1 201 and the user device 2 202 in the second period expressed as shown in equation 10, minimizing the time of transmitting a requested file to the user devices may correspond to an equivalent of maximizing the transmission rates of the user devices. Then, the combination of transmission amounts of the user device 1 201 and the user device 2 202 may be determined from the sets existing in the outermost area of the C_{BC}(P) set. That is, the combination of transmission rates may be determined from a set ((R₂⁽⁴⁾,R₁⁽⁴⁾),(R₂⁽³⁾,R₁⁽³⁾)) corresponding to the boundary, among the combination of transmission rates included in the area 540 of F(P3) of FIG. 5 (i.e., a combination of transmission rates included in the C_{BC}(P) set). As a result on the basis of the condition of the boundary, if a transmission rates of one user device among the transmission rates of the user device 1 201 and user device 202 is determined, a transmission amount of the other user device may be automatically determined.

For example, if the magnitude of the channel of the user device 1 is larger than the magnitude of the channel of the user device 2, the transmission amount adjustment unit 223 may determine the transmission rate R₂⁽⁴⁾ of a point where the transmission amount per second of the user device 2 is the maximum in the F(P3) area as a transmission rate of the user device 2. If r_{2,2} of the point at which the boundary of condition 1 meets the r_{2,2} axis in the (r_{1,2}, r_{2,2}) coordinates is smaller than or equal to R₂^{max}, (R₁⁽⁴⁾,R₂⁽⁴⁾⁾ is (0, R₂^{max}). Otherwise, (R₁⁽⁴⁾,R₂⁽⁴⁾) becomes the intersection point between the boundary of condition 1 and the boundary of condition 3 as illustrated in FIG. 5. In addition, the transmission amount adjustment unit 223 may determine the transmission rate R₁⁽⁴⁾ corresponding to the transmission rate R₂⁽⁴⁾ of a point where the transmission amount per second of the user device 2 is the maximum in the F(P3) area, as a transmission rate of the user device 1. Here, the point where the transmission amount per second of the user device 2 is the maximum in the F(P3) area may represent a point where the power used to transmit the file to the user device 2 is the maximum among the points satisfying condition 1, condition 2, and condition 3 of equation 10. Like this, if the transmission amount of the user device 2 is determined as R₂⁽⁴⁾, the transmission amount of the user device 1 may be determined as R₁⁽⁴⁾. Contrarily, if the transmission amount of the user device 1 is determined first on the basis of the combination as described above, the transmission amount of the user device 2 may be automatically determined.

At this point, since the transmission rate of each user device is determined on the basis of power used by the base station for each user device, as a result, if a power for one user device is determined, the transmission amount adjustment unit 223 may determine a combination of the transmission amounts per second of two user devices on the basis of equation 11 shown below.

$${min}_{{P}_{2}} {\overline{T}}^{HC} ( {P}_{2} ) \\ s . t . {P}_{2}^{( 3 )} \leq {P}_{2} \leq {P}_{2}^{( 4 )} \qquad [ Equation 11 ]$$

In equation 11, target object T̅^{HC} (P₂) may be expressed as a simplified problem as shown in equation 12.

$${\overline{T}}^{HC} ( {P}_{2} ) = \frac{{R}_{1}^{max} - {log}_{2} ( 1 + {\vert {h}_{2} \vert}^{2} {P}_{2} )}{{log}_{2} ( 1 + {\vert {h}_{1} \vert}^{2} {P}_{2} ) + {log}_{2} ( 1 + {\vert {h}_{2} \vert}^{2} {P}_{2} ) - {R}_{1}^{max}} \qquad [ Equation 12 ]$$

In equation 11, P₂⁽³⁾ may denote a power for accomplishing an outer area intersection point of C_{BC}(P) and condition 2 of equation 10 (i.e., an intersection point between the boundary of condition 2 520 and the boundary of F(P3) area 504 (R₁⁽³⁾, R₂⁽³⁾)). In addition, P₂⁽⁴⁾ may denote a power for maximizing the transmission rate of the user device 2 among the possible combination of transmission rates (i.e., F(P3) area 504). Accordingly, the simplified problem of equation 12 may be analyzed again as a problem of minimizing the transmission time among powers that can be allocated to user device 2 202 by the base station. Here, solving the simplified problem, the shape of target function T̅^{HC} (P₂) may vary depending on situations (i.e., the magnitude of a wireless channel).

For example, when the magnitude of the channel of the user device 1 201 is smaller than or equal to the magnitude of the channel of the user device 2 202 and f₅ (P₂=P₂⁽³⁾<f₆ (P₂=P₂⁽³⁾) (see equation 13), the transmission amount adjustment unit 223 may determine the transmission rate R₂⁽³⁾ of a point where the transmission amount per second of the user device 2 202 is the minimum in the boundary of condition 3 in the F(P3) area 540 as a transmission rate of the user device 2 202. When the condition of f₅ (P₂=P₂⁽³⁾<f₆ (P₂=P₂⁽³⁾) is satisfied, the target function becomes a monotone increasing function. Accordingly, under the condition of f₅ (P₂=P₂⁽³⁾<f₆ (P₂=P₂⁽³⁾), a point where the power for the user device 2 202 is minimized (i.e., R₂⁽³⁾ of FIG. 5) may become an optimal solution. Here, f₅ and f₆ may correspond to the functions determining the shape when the target function and the conditions of equation 10 are expressed as a figure.

For another example, when the magnitude of the channel of the user device 1 201 is smaller than or equal to the magnitude of the channel of the user device 2 202 and f₅ (P₂=P₂⁽⁴⁾>f₆(P₂=P₂⁽⁴⁾) (when a point where the transmission amount per second of the user device 2 is the maximum in the F(P3) area becomes an optimal solution), the transmission amount adjustment unit 223 may determine the transmission rate R₂⁽⁴⁾ of a point satisfying the condition (a point where the transmission amount per second of the user device 2 202 is the maximum in the F(P3) area 504) as a transmission rate of the user device 2 202. In addition, the transmission amount adjustment unit 223 may determine the transmission rate R₁⁽⁴⁾ corresponding to the transmission rate R₂⁽⁴⁾ of a point where the transmission amount per second of the user device 2 202 is the maximum in the F(P3) area 540, as a transmission rate of the user device 1 201. When the condition of f₅ (P₂=P₂⁽⁴⁾)>f₆(P₂=P₂⁽⁴⁾) is satisfied, the target function becomes a monotone decreasing function. Accordingly, under the condition of f₅ (P₂=P₂⁽⁴⁾)>f₆ (P₂=P₂⁽⁴⁾), a point where the power for the user device 2 202 is maximized (i.e., R₂⁽⁴⁾ of FIG. 5) may become an optimal solution.

For still another example, when the magnitude of the channel of the user device 1 201 is smaller than or equal to the magnitude of the channel of the user device 2 202 and f₅ (P=P₂⁽⁴⁾)≤f₆ (P₂=P₂⁽⁴⁾) while f₅ (P₂=P₂⁽³⁾) f₆ (P₂=P₂⁽³⁾) (when both of the two conditions in the above two examples are not satisfied), since power P₂′ of P₂′∈[P₂⁽³⁾, P₂⁽⁴⁾] that makes f₅(P₂=P₂′)=f₆ (P₂=P₂′) exists, the target function may become a decreasing function in an area corresponding to a power lower than P₂′ and become an increasing function in an area corresponding to a power higher than P₂′ in the F(P3) area 503. In other words, if both of the two conditions are not satisfied, the target function is not appeared as a monotone increasing or decreasing function, and there may be a turning point. That is, the target function may be changed from a decreasing function to an increasing function. At this point, the changing point may correspond to P₂′. Then, the target function is minimized at P₂′, and P₂′ may be determined as a power for the user device 2 202 accomplishing an optimal solution. That is, a transmission amount per second of the user device 2 2020 in the second period may be determined on the basis of P₂′.

Like this, when target function T̅^{HC} (P₂) changes depending on situations (i.e., the magnitude of a wireless channel), the optimal solution in the second period (the transmission rate of each user device which makes the cumulative transmission amounts of the user device 2 202 and the user device 1 201 equal to each other at the end of the second period) may be summarized as shown in table 2.

TABLE 2

| Conditions | | Optimal rate tuple |
|---|---|---|
| \|h₁\| ≤ \|h₂\| | f₅(P₂ = P₂⁽³⁾) < f₆(P₂ = P₂⁽³⁾) | (R₁⁽³⁾, R₂⁽³⁾) |
| | f₅(P₂ = P₂⁽⁴⁾) > f₆(P₂ = P₂⁽⁴⁾) | (R₁⁽⁴⁾, R₂⁽⁴⁾) |
| | f₅(P₂ = P₂⁽³⁾) ≥ f₆(P₂ = P₂⁽³⁾) and f₅(P₂ = P₂⁽⁴⁾) ≤ f₆(P₂ = P₂⁽⁴⁾) | $( {log}_{2} ( 1 + \frac{{\vert {h}_{2} \vert}^{2} ( P - {P}_{2}^{′} )}{1 + {\vert {h}_{1} \vert}^{2} {P}_{2}^{′}} ) , {log}_{2} ( 1 + {\vert {h}_{2} \vert}^{2} {P}_{2}^{′} ) )$ |

| | |
|---|---|
| \|h₁\| ≤ \|h₂ | (R₁⁽⁴⁾, R₂⁽⁴⁾) |

The equations shown in table 2 may be expressed as shown in equation 13, and (R₁⁽³⁾, R₂⁽³⁾⁾ denotes an intersection point between the boundary of condition 2 and the boundary of condition 3 of equation 10, and (R₁⁽⁴⁾, R₂⁽⁴⁾) may denote a point which maximizes the transmission rate of the user device 2 202 in the F(P3) area 540.

$${f}_{5} ( {P}_{2} ) = \frac{{\vert {h}_{2} \vert}^{2} ( 1 + {\vert {h}_{1} \vert}^{2} {P}_{2} )}{{\vert {h}_{1} \vert}^{2} ( 1 + {\vert {h}_{2} \vert}^{2} {P}_{2} )} \\ {f}_{6} ( {P}_{2} ) = \frac{{log}_{2} ( 1 + {\vert {h}_{2} \vert}^{2} {P}_{2} ) - {R}_{1}^{max}}{{log}_{2} ( 1 + {\vert {h}_{2} \vert}^{2} {P}_{2} )} \qquad [ Equation 13 ]$$

Like this, by obtaining an optimal solution, a file may be transmitted to the user devices 201 and 202 in the second period at a transmission amount per second determined for each user device. That is, a file may be unicast to the user device 2 202 (or the user device 1 201) in the second period at a determined transmission rate of the user device 2 202 (or at a transmission rate of the user device 1 201), and the file may be unicast to user device 1 201 (or the user device 2 202) at a transmission rate of the user device 1 201 (or a transmission rate of the user device 2 202) automatically determined on the basis of the transmission rate of the user device 2 202 (or the transmission rate of the user device 1 201) determined on the basis of the combinations of the transmission rates.

As described above, when a base station provides a file transfer service in the form of hybridcast combining unicast and multicast to user devices requesting the same file at different time points, the base station may transmit the file to the user devices in a shortest time by transmitting the file on the basis of determined transmission amounts per second. In addition, the base station may transmit the file on the basis of an optimum transmission amount of each period for transmitting the file to each user device, considering the magnitude of the wireless channel.

The method according to an embodiment of the present invention may be implemented in the form of a program command that can be performed through various computer means and may be recorded in a computer-readable medium. The computer-readable medium may include program commands, data files, data structures and the like individually or in combination. The program commands recorded in the medium may be commands specially designed and configured for the present invention or commands publicized and used by those skilled in the art of computer software. Examples of the computer-readable recording medium include magnetic media such as a hard disk, a floppy disk and a magnetic tape, optical media such as CD-ROM and DVD, magneto-optical media such as a floptical disk, and hardware devices specially configured to store and perform the program commands, such as ROM, RAM, flash memory and the like. Examples of the program commands include a high-level language code that can be executed by a computer using an interpreter or the like, as well as a machine language code produced by a compiler.

According to the embodiments of the present invention, since a transmission amount per second for transmitting a requested file to at least two or more user devices through a combination of multicast and unicast is proposed, a base station may provide a file transfer service in a minimum time when at least two or more user devices request the same file at different time points.

In addition, since the base station hybridcasts a file by dividing a period of transmitting the file to user devices into a plurality of periods according to the magnitude of a wireless channel between the user devices and the base station, the base station may provide file transfer to the user devices at an optimum transmission amount in the steps corresponding to each period.

Although the embodiments have been described with reference to the limited embodiments and drawings, those skilled in the art can make diverse changes and modifications from the above descriptions. For example, a proper result can be accomplished although the described techniques are performed in a sequence different from that of the methods described above, and/or the constitutional components such as the systems, structures, apparatuses, circuits and the like described above are coupled or combined in a form different from that of the methods described above or substituted or replaced by other constitutional components or equivalents.

Therefore, other implementations, other embodiments and equivalents of the claims also belong to the claims described below.

What is claimed is:

1. A multicast transmission method performed by a base station, the method comprising:
receiving, by a file request reception unit, a request for transmitting a file from a first user device at a first time point;
receiving, by the file request reception unit, a request for transmitting the file from a second user device at a second time point after receiving the request for transmitting the file from the first user device;
transmitting, by a unicast control unit, the file to the first user device in a first period between the first time point and the second time point;
transmitting, by the unicast control unit, the file to each of the first user device and the second user device via unicast transmission in a second period between the second time point and a third time point when a transmission amount of the file transmitted to the first user device becomes equal to a transmission amount of the file transmitted to the second user device; and
transmitting, by a multicast control unit, the file to the first user device and the second user device via multicast transmission from the third time point.

2. The method according to claim 1, further comprising:
adjusting, by a transmission amount adjustment unit, a transmission rate of the first user device and a transmission rate of the second user device in the second period to minimize a completion time of a transmission of the file to the first user device and the second user device.

3. The method according to claim 2, wherein adjusting the transmission rate of the first user device and the transmission rate of the second user device in the second period includes:
adjusting the transmission rate of the first user device and the transmission rate of the second user device on the basis of a channel between the first user device and the base station and a channel between the second user device and the base station

4. The method according to claim 3, wherein adjusting the transmission rate of the first user device and the transmission rate of the second user device in the second period includes:
adjusting the transmission rate of the first user device and the transmission rate of the second user device to meet a first condition that an average transmission rate of the first user device in a period between the first time point and the third time point is greater than or equal to the minimum transmission rate for stable playback of the file, and a second condition that the transmission rates of the first user device and the second user device in the second period are included in available combinations of transmission rates of the base station.

5. The method according to claim 4, wherein adjusting the transmission rate of the first user device and the transmission rate of the second user device in the second period includes:
when a magnitude of the channel of the first user device is greater than a magnitude of the channel of the second user device, adjusting the transmission rate of the second user device to a maximum value that meets the first condition and the second condition.

6. The method according to claim 5, wherein adjusting the transmission rate of the first user device and the transmission rate of the second user device in the second period includes:
adjusting the transmission rate of the second user device to a maximum transmission rate for the second user device according to a transmission power of the base station.

7. The method according to claim 5, wherein adjusting the transmission rate of the first user device and the transmission rate of the second user device in the second period includes:
adjusting the transmission rate of the second user device to a transmission rate of the second user device at an intersection point between a boundary of the first condition and a boundary of the second condition.

8. The method according to claim 4, wherein adjusting the transmission rate of the first user device and the transmission rate of the second user device in the second period includes:
when a magnitude of the channel of the first user device is smaller than or equal to a magnitude of the channel of the second user device and the completion time of the transmission of the file to the first user device and the second user device is a decreasing function of a transmission power for the second user device at a point where the transmission rate of the second user device is a maximum value that meets the first condition and the second condition, adjusting the transmission rate of the second user device to the maximum value that meets the first condition and the second condition.

9. The method according to claim 8, wherein adjusting the transmission rate of the first user device and the transmission rate of the second user device in the second period includes:
adjusting the transmission rate of the second user device to a maximum transmission rate for the second user device according to a transmission power of the base station.

10. The method according to claim 8, wherein adjusting the transmission rate of the first user device and the transmission rate of the second user device in the second period includes:
adjusting the transmission rate of the second user device to a transmission rate of the second user device at an intersection point between a boundary of the first condition and a boundary of the second condition.

11. The method according to claim 4, wherein adjusting the transmission rate of the first user device and the transmission rate of the second user device in the second period includes:
when a magnitude of the channel of the first user device is smaller than or equal to a magnitude of the channel of the second user device and the completion time of the transmission of the file to the first user device and the second user device is not a decreasing function of a transmission power for the second user device at a point where the transmission rate of the second user device is a maximum value that meets the first condition and the second condition, adjusting the transmission rate of the second user device to
$$( {log}_{2} ( 1 + \frac{{\vert {h}_{2} \vert}^{2} ( P - {P}_{2}^{′} )}{1 + {\vert {h}_{1} \vert}^{2} {P}_{2}^{′}} ) , {log}_{2} ( 1 + {\vert {h}_{2} \vert}^{2} {P}_{2}^{′} ) ) ,$$
wherein h₁ is a channel between the first user device and the base station, h₂ is a channel between the second user device and the base station, and P₂′ is a transmission power for the second user device at a point where the completion time of the transmission of the file to the first user device and the second user device changes from a decreasing function of the transmission power for the second user device to an increasing function of the transmission power for the second user device.

12. A multicast transmission system including a base station, the system comprising:
a file request reception unit for receiving a request for transmitting a file from a first user device at a first time point, and receiving a request for transmitting the file from a second user device at a second time point after receiving the request for transmitting the file from the first user device;
a unicast control unit for transmitting the file to the first user device in a first period between the first time point and the second time point, and transmitting the file to each of the first user device and the second user device via unicast transmission in a second period between the second time point and a third time point when a transmission amount of the file transmitted to the first user device becomes equal to a transmission amount of the file transmitted to the second user device; and
a multicast control unit for transmitting the file to the first user device and the second user device via multicast transmission from the third time point.

13. The system according to claim 12, further comprising:
a transmission amount adjustment unit for adjusting a transmission rate of the first user device and a transmission rate of the second user device in the second period to minimize a completion time of a transmission of the file to the first user device and the second user device.

14. The system according to claim 13, wherein the transmission amount adjustment unit adjusts the transmission rate of the first user device and the transmission rate of the second user device on the basis of a channel between the first user device and the base station and a channel between the second user device and the base station

15. The system according to claim 14, wherein the transmission amount adjustment unit adjusts the transmission rate of the first user device and the transmission rate of the second user device to meet a first condition that an average transmission rate of the first user device in a period between the first time point and the third time point is greater than or equal to the minimum transmission rate for stable playback of the file, and a second condition that the transmission rates of the first user device and the second user device in the second period are included in available combinations of transmission rates of the base station.

16. The system according to claim 15, wherein the transmission amount adjustment unit adjusts, when a magnitude of the channel of the first user device is greater than a magnitude of the channel of the second user device, the transmission rate of the second user device to a maximum value that meets the first condition and the second condition.

17. The system according to claim 16, wherein the transmission amount adjustment unit adjusts the transmission rate of the second user device to a transmission rate of the second user device at an intersection point between a boundary of the first condition and a boundary of the second condition.

18. The system according to claim 15, wherein the transmission amount adjustment unit adjusts, when a magnitude of the channel of the first user device is smaller than or equal to a magnitude of the channel of the second user device and the completion time of the transmission of the file to the first user device and the second user device is a decreasing function of a transmission power for the second user device at a point where the transmission rate of the second user device is a maximum value that meets the first condition and the second condition, the transmission rate of the second user device to the maximum value that meets the first condition and the second condition.

19. The system according to claim 15, wherein the transmission amount adjustment unit adjusts, when a magnitude of the channel of the first user device is smaller than or equal to a magnitude of the channel of the second user device and the completion time of the transmission of the file to the first user device and the second user device is not a decreasing function of a transmission power for the second user device at a point where the transmission rate of the second user device is a maximum value that meets the first condition and the second condition, the transmission rate of the second user device to
$$( {log}_{2} ( 1 + \frac{{\vert {h}_{2} \vert}^{2} ( P - {P}_{2}^{′} )}{1 + {\vert {h}_{1} \vert}^{2} {P}_{2}^{′}} ) , {log}_{2} ( 1 + {\vert {h}_{2} \vert}^{2} {P}_{2}^{′} ) ) ,$$
wherein h₁ is a channel between the first user device and the base station, h₂ is a channel between the second user device and the base station, and P₂′ is a transmission power for the second user device at a point where the completion time of the transmission of the file to the first user device and the second user device changes from a decreasing function of the transmission power for the second user device to an increasing function of the transmission power for the second user device.

20. A computer-readable recording medium recording a program for executing the method according to claim 1.
